(19) United States
(12) Patent Application Publication
(10) Pub. No.: US 2012/0001102 A1
(43) Pub. Date: Jan. 5, 2012

(54) HIGHLY CLEAN AND HOT VALVE

(75) Inventors: Yasuhiro Chiba, Miyagi (JP); Kohei Yamamoto, Miyagi (JP); Hiroshi Takada, Tokyo (JP); Kota Koizumi, Tokyo (JP); Yasushi Yagi, Tokyo (JP); Shingo Watanabe, Tokyo (JP); Yuji Ono, Tokyo (JP); Hiroshi Kaneko, Tokyo (JP); Koyu Hasegawa, Tokyo (JP)

(73) Assignees: Tokyo Electron Limited, Tokyo (JP); Ham-Let Motoyama Japan Ltd., Miyagi (JP)

(21) Appl. No.: 12/864,382

(22) PCT Filed: Jan. 21, 2009
(86) PCT No.: PCT/JP2009/050873

§ 371 Date: Oct. 18, 2010

(30) Foreign Application Priority Data
Jan. 23, 2008 (JP) 2008-013177

(51) Int. Cl. F16K 31/122

(52) U.S. Cl. 251/11

(57) ABSTRACT

A highly clean and high temperature valve apparatus includes a valve driving unit and a valve casing connected to a bonnet supporting a valve stem slidably. A stem portion has one end positioned in a circumferential wall closed at its two ends by upper and lower covers, and supports one end of the valve stem with its other end extending through the lower cover. The stem portion has its ends supported respectively by first and second bellows for closing an axial through hole of the lower cover tightly. A first pipe communicates with a first space isolated by the first bellows, and a second pipe communicates with a second space isolated by the first bellows. The fluid quantities in the first and second spaces are increased or decreased relative to each other, thereby to drive the stem portion supported in a floating state by the first and second bellows.

### TECHNICAL FIELD

The present invention is related to highly clean and high temperature valves that control or block the flow volume of a fluid used for semiconductor manufacturing machines producing products including semiconductor memory devices or various manufacturing machines including FPD manufacturing machines for light-emitting diodes (LEDs), electroluminescence (EL) devices, vacuum fluorescent displays (VFDs), plasma display panel (PDPs), or other devices.

### BACKGROUND OF THE INVENTION

Patent Reference 1: Japanese Unexamined Patent Application Publication No. H06-074363
Patent Reference 2: Japanese Unexamined Patent Application Publication No. H11-153235

It is known that highly clean and high temperature valves are used for semiconductor manufacturing machines producing products including semiconductor memory devices or various manufacturing machines including FPD manufacturing machines for light-emitting diodes (LEDs), electroluminescence (EL) devices, vacuum fluorescent displays (VFDs), plasma display panel (PDPs), or other devices in order to control the flow volume of a liquid used for manufacturing.

Such a highly clean and high temperature valve typically uses accordion shaped bellows as sealing materials to reduce external leakage (e.g., see Patent References 1 and 2).

FIG. 11 shows cross-sectional view of the highly clean and high temperature valve that uses bellows as sealing materials to reduce external leakage, for example.

In FIG. 11, the highly clean and high temperature valve 1 includes a valve stem 2, a bonnet 3 supporting a valve stem 2 slidably, a valve driving unit 4 driving the valve stem 2 with the bonnet 3 connected so that one end of the valve stem 2 is supported, a valve casing 5 connected with the bonnet 3 so that the casing is positioned at the opposite side of the valve stem 2. a valve casing 6 fixed at the opposite side of the valve stem 2, and bellows 7 as valve stem sealing material positioned between the bonnet 3 and valve casing 5 so that the bonnet and valve casing encircle the vicinity of other end of the valve stem 2.

The valve stem 2 includes a stem portion 2a fixed to the side of a valve driving unit 4 and a valve axis main unit 2b connected with the tip of the stem portion 2a inside the bonnet 3.

The bonnet 3 is connected with the valve driving unit 4 with a fixture (not indicated in a figure) including a screw and is bonded to the valve casing 5 through welding with external leakage reduced. Moreover, a sealing material 8 through which the valve stem 2 passes to further reduce external leakage at the contact area between the bonnet 3 and valve casing 5, one end of the bellows 7 is connected with the sealing material 8, and the other end of the bellows 7 is connected with the valve casing 6.

The valve driving unit 4 employs a cylinder structure, whose inside is provided with a spring 9 biasing a valve seat 6 to the direction where the valve maintains always close via the valve stem 2, and a base 10 supporting one end of the valve stem 2 (one end of the axis segment 2a) and biasing and contacting with one end of the spring 9. A sealing material 10a such as a resin-made O ring is placed between the base 10 and the internal space of the valve driving unit 4.

### DISCLOSURE OF THE INVENTION

### Problems to be Resolved by the Invention

Meanwhile, a highly clean and high temperature valve 1 configured as above involves a problem of low versatility as a valve apparatus for usage environment.

The problem is that, for example, the highest temperature under which the valve apparatus operates is determined by the allowable temperature limit of the resin material used for the sealing material 10a placed at the base 10.

Moreover further problem has arisen. Although the valve stem 2, valve casing 5, and bellows 7 are connected and fixed to reduce external leakage, it is difficult to operate the valve apparatus in a vacuum since the external leakage has not been considered for the bonnet 3 and valve driving unit 4.

In addition, further problem has occurred because sliding segments (through-hole segments) of the valve stem 2 are placed for each of the bonnet 3 and valve driving unit 4. This structure adversely impacts on the sealing function (performance for valve closing) of the valve body 6 due to the misalignment of the axial line when the bonnet 3 and valve driving unit 4 are linked (linkage between the axial segment 2a and valve axis main body 2b).

Furthermore another problem has arisen. Lubricant or the like must be applied to the sliding faces of the bonnet 3 and the valve driving unit 4 to reduce the axial sliding resistance upon the operation of the valve stem 2. The allowable operating temperature as a valve apparatus is limited depending on the type of lubricant.

When such a valve apparatus is heated using a heating object such as a heater, variations in heating efficiency are generated according to the contact conditions between the bonnet 3 and the valve driving unit 4 and between the bonnet 3 and the valve casing 5.

The present invention is aimed to provide a highly clean and high temperature valve that enhances the general versatility as a valve apparatus for usage environment to resolve the problems above.

To achieve the goal, the highly clean and high temperature valve described in claim 1 is characterized by a structure that incorporates a valve stem, a bonnet supporting the valve stem slidably, a valve driving unit that drives the valve stem linked to the bonnet to support one end of the valve stem, and a valve casing that is linked to the bonnet so that the valve casing is positioned at the other end of the valve stem, wherein the highly clean and high temperature valve includes the valve driving unit that is positioned in a circumferential wall closed at its two ends by an upper cover and a lower cover, a stem portion whose one end is positioned at the inside of the circumferential wall and supports the one end of the valve stem with its other end extending through the lower cover, a first bellows linked to the one end of the stem portion so that the inside of the circumferential wall is isolated by the upper cover side and lower cover side, a second bellows that opens or closes the axial through hole of the lower cover positioned between the lower cover and the other end of the axial portion, a first pipe that is made to communicate with a first space isolated by the first bellows, a second pipe that is made to communicate with a second space that is isolated by the first bellows, isolated to the external space by the second bellows, and formed between the lower cover and the one end of the stem portion, wherein the fluid quantities in the first and second spaces are increased or decreased relative to each other, thereby to drive the stem portion with the first and second bellows.

Such a structure makes connection by means of welding possible by applying a metal material to the structural material of the valve driving unit. Moreover, it is possible to maintain airtightness of the valve driving unit, and enhance the general versatility as a valve apparatus due to improvement of heat resistance property.

Moreover, the stem portion is supported in a floating state by the first and second bellows inside the circumferential wall. In addition, inserting the stem portion into the axial through hole in a non-contact state makes it possible to eliminate the need for a bearing at stem portions in the stem driving unit. Furthermore, precise mechanical axis alignment between the center of the stem portion supporting the valve stem and the center of the axis supporting portion of the bonnet, thus increasing workability for combining the bonnet and valve driving unit and the performance of valve opening and closing.

The bonnet, moreover, supports the valve stem slidably and is provided with a bearing member whose material differs in the mechanical property from that of the external circumferential sliding face of the valve stem at the internal circumferential sliding face. This arrangement make it possible to enhance the general versatility as a valve apparatus to be enhanced since application of lubricant or the like to the sliding portion of the valve stem is not necessary, and thus alleviating the allowable temperature limit.

In this case, it is possible to enhance the general versatility as a valve apparatus by means of alleviating the allowable temperature limit by using a metal material whose hardness differs from that of the external circumferential sliding face of the valve stem as a bearing material, and thus reducing friction resistance easily.

The bonnet and the valve driving unit are tightly connected and the bonnet is provided with a purge port that control purges in a tightly closed space between the bonnet and the valve driving unit. This arrangement makes the valve apparatus be suitable for the use in a vacuum.

In this case, it is possible to easily maintain air tightness by arranging a metal gasket at the contact area between the bonnet and the valve driving unit, and at the contact area between the bonnet and the valve casing. This arrangement further makes the valve apparatus be suitable for the use in a vacuum.

Moreover, variation of heating effect in the valve casing can be reduced by incorporating a heating object inside the valve casing.

In this case, by providing another heating body in addition to the one at the inside of the valve casing, at the inside of the valve stem, a temperature variation of the inside of the valve casing can easily be made even, and by providing heating bodies at the inside of the valve stem and the inside of the valve casing in combination, heating effect can be increased and a temperature variation of heating effect can be reduced.

Moreover, a second valve driving unit is positioned at the upper stage of the valve driving unit, wherein the second valve driving unit includes a second circumferential wall, a second upper cover and a second lower cover that close the both ends of the circumferential wall, a second stem portion having one end positioned in the circumferential wall and extending through the lower cover and the stem portion coaxially as well as the valve stem, a second first bellows linked to the one end of the second stem portion so that the inside of a second circumferential wall is isolated by the second upper cover side and the second lower cover side, a second second bellows that is positioned between a second lower cover and the other end of the stem portion, a second first pipe that is made to communicate with a second first space formed between the second upper cover isolated by the second first bellows and one end of the second stem portion, a second second pipe that is made to communicate with a second second space formed between the second lower cover isolated by the second first bellows and isolated by the second second bellows from external environment and one end of the second stem portion, thereby enabling to increase airtightness against external space by driving the second stem portion by increasing and decreasing the fluid quantities in the first and second spaces relative to each other through the second first and second pipes.

In this case, the number of parts can be reduced by the one upper cover utilized for both the second lower cover and the upper cover.

Moreover, by positioning a diaphragm made of a metal film that opens or closes the flow channel formed in the valve casing by a drive of the valve stem for the valve casing, the present valve is idealistically used as a highly clean valve and further enhances its general versatility as a valve apparatus.

Similarly, by positioning a diaphragm made of a metal film that opens or closes the flow channel formed in the valve casing by a drive of the second valve stem for the second valve stem, the present valve is idealistically used as a highly clean valve and further enhances its general versatility as a valve apparatus.

In this case, Rma×0.1 micrometers or less of surface roughness of the diaphragm can maintain higher tightness for the flow channel.

### Effect of the Invention

According to the highly clean and high temperature valve in the present invention, it is possible to enhance the general versatility as a valve apparatus for usage environment, more particularly, the highly clean and high temperature valve can operate under an environment at as high as 300 degrees centigrade or higher or under a vacuum environment, and moreover, can operate as a valve apparatus with high cleanliness.

### BRIEF DESCRIPTION OF THE DRAWINGS

FIG. 1 A vertical cross sectional view of the highly clean and high temperature valve of the example related to one embodiment (Embodiment 1) of the present invention.

FIG. 2 A cross sectional view from other direction of the highly clean and high temperature valve of the example related to one embodiment (embodiment 1) of the present invention.

FIG. 3 A graph of the temperature profiles comparing a case where the valve casing is heated with an internal heater (heating body) using the highly clean and high temperature valve of the present invention and a case the valve casing is heated using an external heater

FIG. 4 A vertical cross sectional view of the highly clean and high temperature valve of embodiment 2 related to one embodiment of the present invention

FIG. 5 A vertical cross sectional view of the highly clean and high temperature valve of embodiment 3 related to one embodiment of the present invention

FIG. 6 A vertical cross sectional view of the highly clean and high temperature valve of embodiment 4 related to one embodiment of the present invention

FIG. 7 A vertical cross sectional view from other direction of the highly clean and high temperature valve of embodiment 4 related to one embodiment of the present invention

FIG. 8 A vertical cross sectional view of the highly clean and high temperature valve of embodiment 5 related to one embodiment of the present invention

FIG. 9 A vertical cross sectional view from other direction of the highly clean and high temperature valve of embodiment 5 related to one embodiment of the present invention

FIG. 10 A vertical cross sectional view of the highly clean and high temperature valve of embodiment 6 related to one embodiment of the present invention

FIG. 11 A cross sectional view of a conventional highly clean and high temperature valve

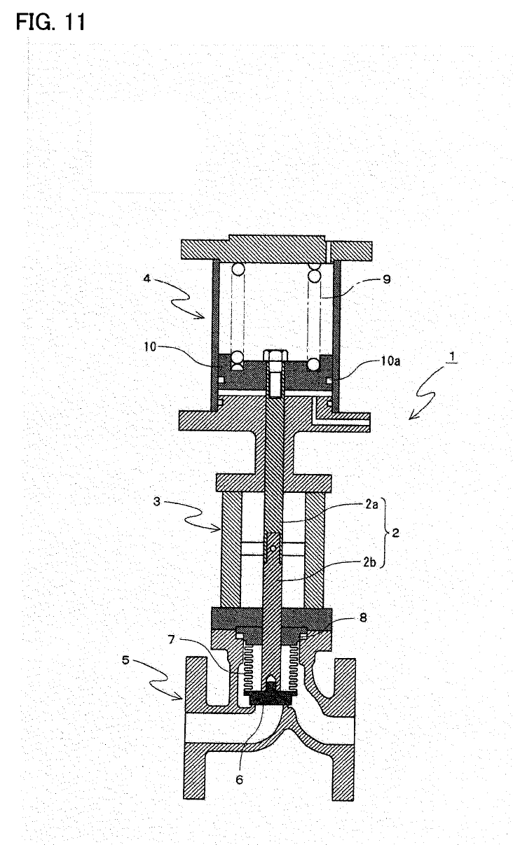

### DESCRIPTION OF THE SYMBOLS

11 Highly clean and high temperature valve
12 Valve stem
13 Metal gasket
14 Metal gasket
15 Highly clean and high temperature valve
16 Highly clean and high temperature valve
17 Highly clean and high temperature valve
18 Highly clean and high temperature valve
20 Bonnet
21 Bearing member
22 Purge port
23 Linkage flange portion
24 Linkage flange portion
25 Third bellows
26 Diaphragm
27 Cylinder portion
30 Valve driving unit
31 Circumferential wall
31a Second pipe
32 Upper cover
32a First pipe
33 Lower cover
33a Axial through hole
34 Stem portion
34a Separation wall
34b Heater insertion hole
35 First bellows
36 Second bellows
37 First space
38 Second space
39 Heating body
40 Valve casing
41 Heating body
42 Pipe at the air intake side
43 Air intake channel
44 Pipe at the air exhaust side
45 Air exhaust channel
46 Control room
50 Valve casing
52 Pipe at the air intake side
53 Air intake channel
54 Pipe at the air intake side
55 Air intake channel
56 Pipe at air exhaust side
57 Air exhaust side
60 Valve casing
61 Ferroelectric substance film material vaporization apparatus (vaporizer)
62 Pipe at air intake side
63 Air intake channel
64 Pipe at air exhaust side
65 Air exhaust channel (vaporization material introduction line)
66 Pipe at exhaust side
67 Air exhaust channel (material vent line)
68 External heating body
69 Vaporization material processing apparatus (chamber)
70 Valve driving unit
71 Circumferential wall
71a Second pipe
72 Upper cover
72a First pipe
74 Stem portion
75 First bellows
76 Second bellows
77 First space
78 Second space
79 Diaphragm

### BEST MODE FOR CARRYING OUT THE INVENTION

From this paragraph, the highly clean and high temperature valve in accordance with an embodiment of the present invention is explained based on the drawings.

### EMBODIMENT

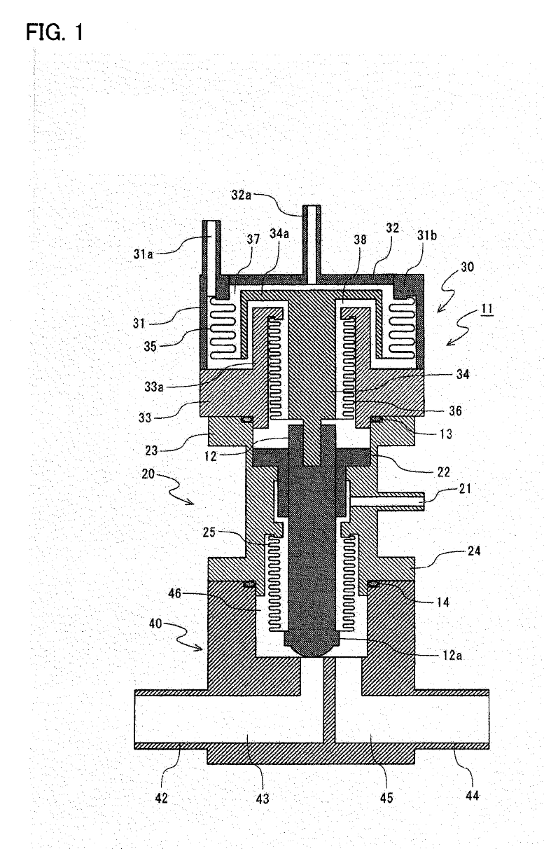

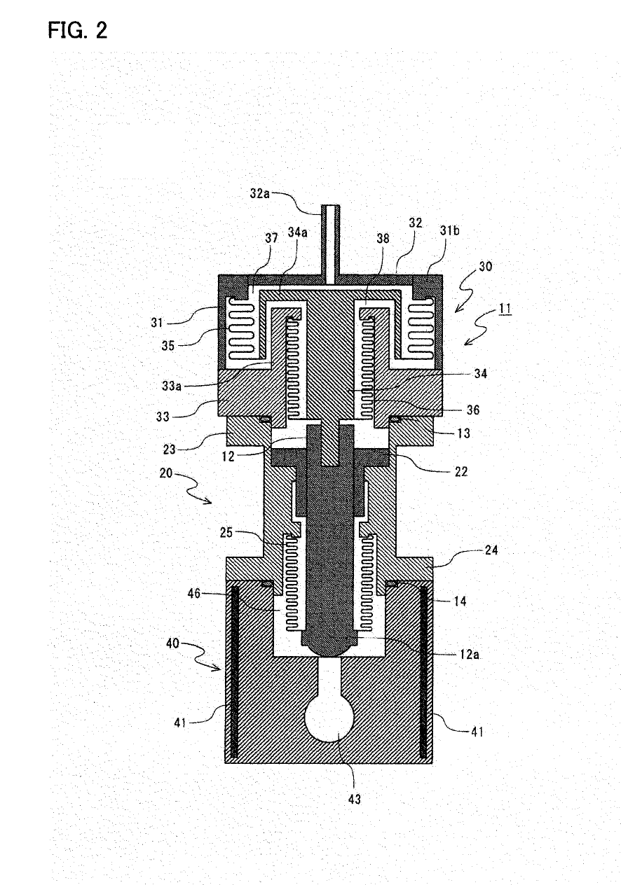

FIGS. 1 and 2 shows the highly clean and high temperature valve related to one embodiment of the present invention; FIG. 1 illustrates a vertical cross sectional view of the highly clean and high temperature valve in the embodiment in accordance with an embodiment of the present invention, FIG. 2 illustrates a vertical cross sectional view from other direction of the highly clean and high temperature valve in the embodiment in accordance with an embodiment of the present invention.

In these figures, a highly clean and high temperature valve 11 comprises a valve stem 12, a bonnet 20 supporting the valve stem 12 slidably, a valve driving unit 30 linked with the bonnet 20 so that the valve driving unit 30 supports one end of the valve stem 12 to drive the valve stem 12, and a valve casing 40 linked with the bonnet 20 so that the valve casing 40 is positioned at other side of the valve stem 12.

The valve driving unit 30 comprises a circumferential wall 31, an upper cover 32 and a lower cover 33 that close the both ends of the circumferential wall 31, a stem portion 34 that has one end positioned in the circumferential wall and supports one end of the valve stem 12 with its other end extending through the lower cover 33, a first bellows 35 linked to one end of the stem portion 34 so that the inside of the circumferential wall 31 is isolated by the upper cover side 32 and lower cover side 33, a second bellows 36 that is positioned between the lower cover 33 and the other end of stem portion 34 and tightly closes an axial through hole 33a of the lower cover 33, a first pipe 32a is made to communicate with a first space 37 formed between the upper cover 32 isolated by the first bellows 35 and one end of the stem portion 34, and a second pipe 31a that is made to communicate with a second space 38 formed between the lower cover 33 isolated by the first bellows 35 and isolated by the second bellows 36 from external environment and one end of the stem portion 34; thereby driving the stem portion 34 by increasing or decreasing the fluid quantities in the first space 37 and the second space 38 relative to each other through the first pipe 31a and the second pipe 32a.

This arrangement makes it possible to connect the circumferential wall 31 and the upper cover 32, and the circumferential wall 31 and the lower cover 33, which are components of the valve driving unit 30, by means of welding using the metal material of each components, thereby enabling for the valve driving unit 30 to easily maintain airtightness and increase heat resistance and the general versatility as a valve apparatus. Metal materials can also be used for the stem portion 34, the first bellows 35, and the second bellows 36, which are components of the valve driving unit 30. For example, the first bellows 35 is connected with circumferential wall 31 and stem portion 34, and the second bellows 36 is connected with the lower cover 33 and stem portion 34 by means of welding, thereby enabling for the valve driving unit 30 to easily maintain airtightness and increase heat resistance and general versatility as a valve apparatus. It is, moreover, possible to use the valve apparatus in a vacuum by improving its airtightness as high as possible.

Stem portion 34 is supported in a floating state in the circumferential wall 31 by the first and second bellows 35 and 36, and the stem portion 34 passes through the axial through hole 33a without contact.

This arrangement makes the flexible centering of the stem portion 34 possible using flexing characteristics of bellows 35 and 36. Since the stem portion 34 passes through the axial through hole 33a, which is a flexible hole, this allows the centering of the axial center of the stem portion 34 over a wide range. Therefore, the alignment of axial centers of the valve stem 12 and stem portion 34 when the bonnet 20 and the valve driving unit 30 is made by simply linking the valve stem 12 with the valve portion 34, which almost eliminates the need for consideration of combination errors between the bonnet 20 and the valve driving unit 30 and molding errors.

Moreover, the bonnet 20 is provided with a bearing member 21 that supports the valve stem 12 slidably, and a material whose mechanical characteristics differ from the material used for the external sliding face of the valve stem 12 is welded to the bearing member 21 at the internal sliding face. The bearing member 21 is made of a metallic material whose hardness differs from that of the external sliding face of the valve stem 12.

This arrangement eliminates the need for application of lubricant that smoothly slides the valve stem 12. Since the valve apparatus is not affected by the heat resistance characteristics of lubricant, the valve apparatus can be used under temperatures of 300 degrees centigrade or higher.

The bonnet 20 and the valve driving unit 30 are airtightly connected, and a purge port 21 that controls the purge in an airtight space between the bonnet 20 and the valve driving unit 30 is provided.

Because of such an arrangement, the purge port 21 that communicates between internal side and external side can be used as a sole pipe, which eliminates the need for using complicated structure and is suited for the use in a vacuum environment. In this case, sealing metal gaskets 13 and 14 are used for connection areas between the bonnet 20 and the valve driving unit 30 and between the bonnet 20 and the valve casing 40 for maintaining tightness, thereby increasing the general versatility for a use in a vacuum. Moreover, incorporation of a heating body 41 such as a heater inside the valve casing 40 can reduce variation of heating efficiency of the valve casing 40, and the use of metal gaskets 13 and 14 increases the heat resistance of the valve apparatus and enables it to be used in an environment with a temperature of 300 degree centigrade or higher.

### Embodiment 1

From this paragraph, an embodiment of a highly clean and high temperature valve 11 in accordance with an embodiment of the present invention is described based on FIGS. 1, 2, and 3.

### (Specific Structure of Bonnet 20)

A bonnet 20 is a cast component made of metal material and has a rough cylindrical shape, which incorporates linkage flange portions 23 and 24 at the both end open areas. A valve stem 12 passes through the bonnet 20. A purge port 21 that communicates between the internal space and external space at the external wall is formed as a protrusion. One end of a third bellows 25 that is made of metal has a connection by such as welding to internal circumferential wall near the middle of the height direction along the axis direction of the bonnet 20. The other end of the third bellows 25 has a connection by such as welding to the area close to the tip of the valve stem 12.

A bearing member 22 is pressed into the internal wall of the bonnet 20, and supports displacement (sliding) in the direction of the stem line of the valve stem 12.

The linkage flange portions 23 and 24 are connected with the valve driving unit 30 and the valve casing 40 via a fixture member (not indicated in figures) such as a bolt, and metal gaskets 13 and 14 are sandwiched at the connections (between contact faces) to maintain airtightness of two elements.

### (Specific Structure of the Valve Driving Unit 30)

The valve driving unit 30 comprises a circumferential wall 31, a upper cover 32, a lower cover 33, stem portion 34, a first bellows 35, and a second bellows 36.

The circumferential wall 31 is formed to almost a cylindrical shape having a flange portion 31b overly hung in the inside at the one open end (the side of upper cover 32). From one portion of the flange portion 31b, a second pipe 31a as a part of the flange portion 31b upwardly protruded. Moreover, one end of a first bellows 35 is connected with the flange portion 31 by welding.

The upper cover 32 is fixed to the internal circumferential face of the flange portion 31b of the circumferential wall 31, and at the middle of the upper cover 32, a first pipe 32a as a part of the cover is upwardly protruded.

The lower cover 33 has a shape of a relatively thick doughnut that is fixed to the circumferential wall 31 by welding, and as a part of the cover, a cylindrical portion 33a through which the stem portion 34 passes is integrally provided.

The stem portion 34 has its one end that links with the valve stem 12. The other end of the stem portion 34 integrally has a separation wall 34a whose cross section is cylindrical shape with base and which encloses a part of the stem portion 34, and has the lower end to which the other end of the first bellows 35 is connected through welding. This arrangement forms, in the valve driving unit 30, virtually a first space 37 between the upper cover 32 and the stem portion 34 due to the first bellows 35 and the separation wall portion 34a, and virtually a second space 38 between the lower cover 33 and the stem portion 34 due to the first bellows 35 and the separation wall 34a.

The first pipe 32a and the second pipe 31a are linked each other in the first space 37 and the second space 38. For example, when a pressured fluid (e.g., gas or air) is supplied from the second pipe 31a, the volume inside the first space 37 increases, driving the valve stem 12 to the downward direction as illustrated via the stem portion 34. Moreover, when a pressured fluid (e.g., gas or air) is supplied from the first pipe 32a, the pressured fluid (e.g., gas or air) in the second space 38 is discharged from the second pipe 31a, decreasing the volume inside the second space 38. Similarly, when a pressured fluid (e.g., gas or air) is supplied from the first pipe 32a, the volume inside the second space 38 increases, driving the valve stem 12 to the upward direction as illustrated via the stem portion 34. Moreover, when a pressured fluid (e.g., gas or air) is supplied from the second pipe 31a, the pressured fluid (e.g., gas or air) in the first space 37 is discharged from the first pipe 32a, decreasing the volume of the first space. The pressured fluid is supplied or took in through the first pipe 32a only, and according to the volume changes in the first space 37 caused by the supply or intake, the pressured fluid can be released or discharged through the second pipe 31a accordingly.

### (Specific Structure of the Valve Casing 40)

The valve casing 40 has an air intake channel 43 integrally provided with an pipe at the air intake side 42, and an air exhaust channel 45 integrally provided with an pipe at the air exhaust side 44, and the open end of the air intake channel 43 is opened or closed with a valve body 12a integrally formed at the tip of the valve stem 12, thereby controlling the fluid according to the degree of opening.

Furthermore, the valve casing 40 has a control room 46 to which the tip portion of the valve stem 12 and a third bellows 25 are positioned due to the linkage with the bonnet 20 tightly and separately from the external space.

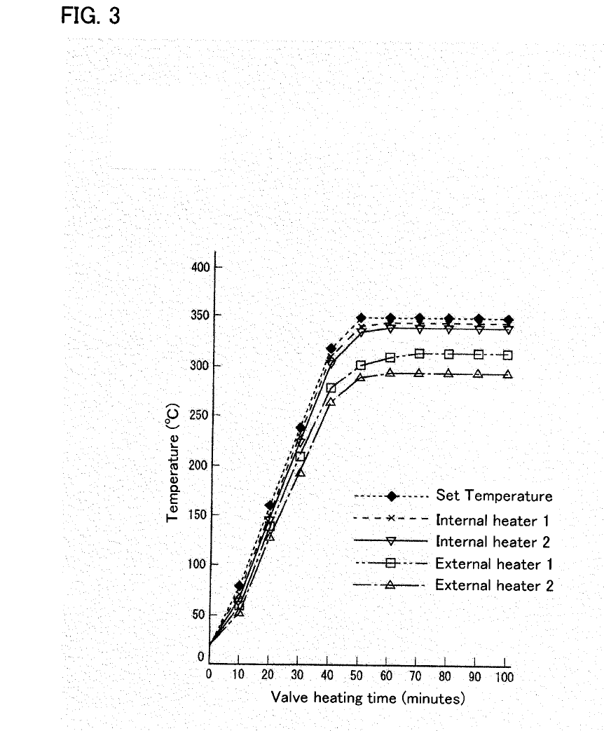

The heating body 41 is a body that passes from the pipe at the air intake side 42, air intake channel 43, control room 46, up to the exhaust channel 45 in this order, and thus heats up the fluid exhausted from the pipe at the air exhaust side 44 while the valve is open. As shown in FIG. 3, higher heating efficiency can be achieved and a 5% or less accuracy against a preset temperature can be maintained in a case where the heating body 41 is positioned at the inside of the valve casing 40 (internal heaters 1 and 2) than a case where the heating body 41 is positioned at the outside of the valve casing 40 (external heaters 1 and 2).

In the graphs in FIG. 3, the measurement result for the internal heater 1 and external heater 1 is obtained at the location close to the external circumference of the valve casing 40 in FIG. 2, and the measurement result for the internal heater 2 and external heater 2 is obtained at the location close to the center of the valve casing 40 in FIG. 2.

### Embodiment 2

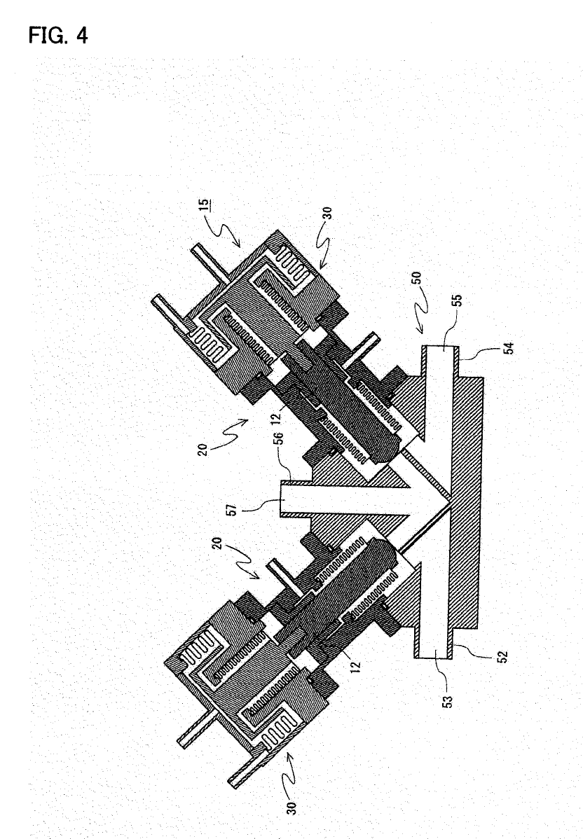

FIG. 4, which shows the second example of the embodiment of a highly clean and high temperature valve in accordance with an embodiment of the present invention, is a vertical cross sectional view of the highly clean and high temperature valve. Only representative symbols are used for the organization that is the same as that mentioned in Embodiment 1, and detailed explanation for them are omitted in FIG. 4.

In a highly clean and high temperature valve 15 in the Embodiment 2, the valve casing 40 of the Embodiment 1 is changed to the valve casing 50 including a complex valve (mixing valve) with a plurality of (two) valves. Both valves include the valve stem 12, the bonnet 20 supporting the valve stem 12 slidably, and the valve driving unit 30 driving the valve stem 12 connected with the bonnet 20 so that the valve driving unit 30 supports one end of the valve stem 12, and the valve casing 50 is coupled with the bonnet 20 so that valves can be positioned at the other end side of each of valve stem 12.

The valve casing 50 has an air intake channel 53 integrally provided with an pipe at the air intake side 52 for one valve, an air intake channel 55 integrally provided with an pipe at the air intake side 54 for another valve, and an air exhaust channel 57 integrally provided with a pipe at the air exhaust side 56, thereby mixing two types of fluids (both gas and liquid) by means of the single air exhaust channel 57.

### Embodiment 3

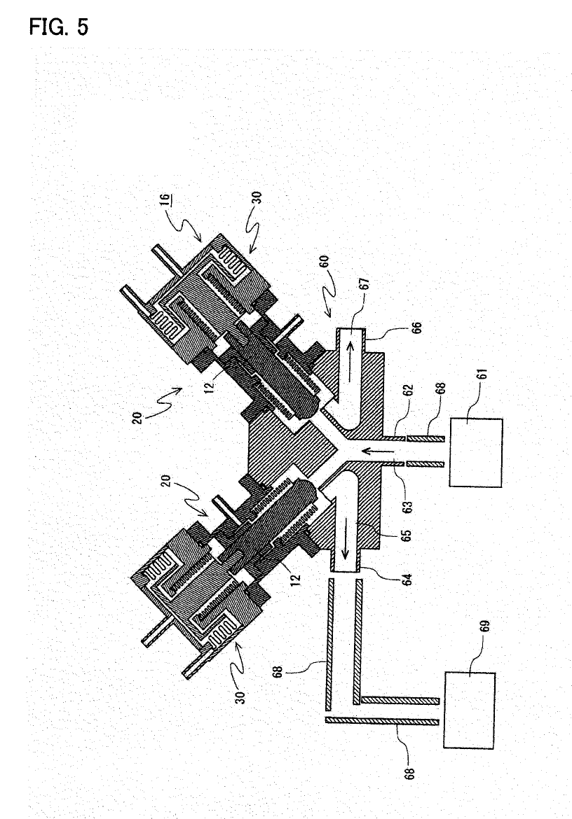

FIG. 5, which shows the third example of the embodiment of a highly clean and high temperature valve in accordance with an embodiment of the present invention, is a vertical cross sectional view of the highly clean and high temperature valve. Only representative symbols are used for the organization that is the same as that mentioned in Embodiment 1, and detailed explanation for them are omitted in FIG. 5.

In a highly clean and high temperature valve 16 in the Embodiment 3, the valve casing 40 of the Embodiment 1 is changed to the valve casing 60 including a complex valve (mixing valve) with a plurality of (two) valves that is used for liquid material vaporization carrier device. Both valves include the valve stem 12, the bonnet 20 supporting the valve stem 12 slidably, and the valve driving unit 30 driving the valve stem 12 connected with the bonnet 20 so that the valve driving unit 30 supports one end of the valve stem 12, and the valve casing 60 is coupled with the bonnet 20 so that valves can be positioned at the other end side of each of valve stem 12.

The valve casing 60 has, for example, an air intake channel 63 integrally provided with a pipe at the air intake side 62 for material carrier gas (carrier gas) from ferroelectric film material vaporization device (vaporizer) for both valves, an air intake channel 65 (e.g., vaporization material introduction line) integrally provided with a pipe at the air exhaust side 64 for one valve, and an air exhaust channel 67 (e.g., material vent line) integrally provided with a pipe at the air exhaust side 66 for another valve. The valve casing 60 also has an external heating body 68 heating the fluid for promoting vaporization around the pipes (not shown in a figure) connected with the pipe at the air intake side 62 and the pipe at the air exhaust side 64. The pipe at the exhaust side 64 is connected with a vaporization material processing device (chamber) 69.

### Embodiment 4

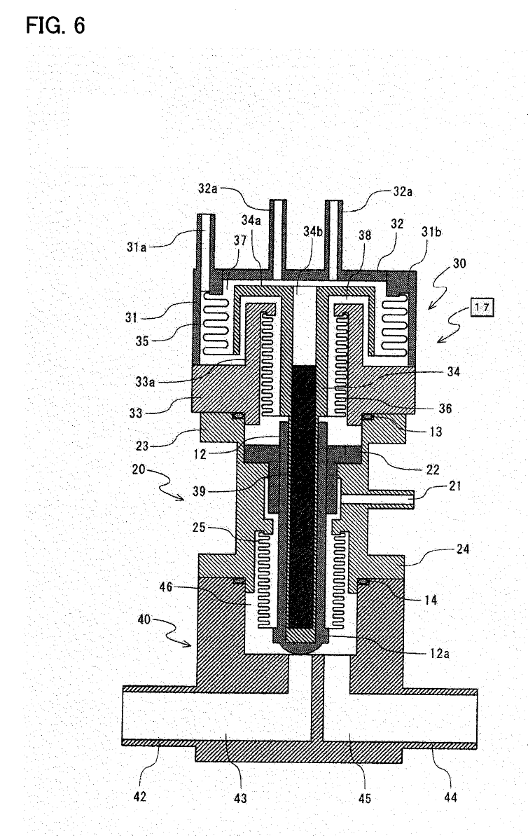

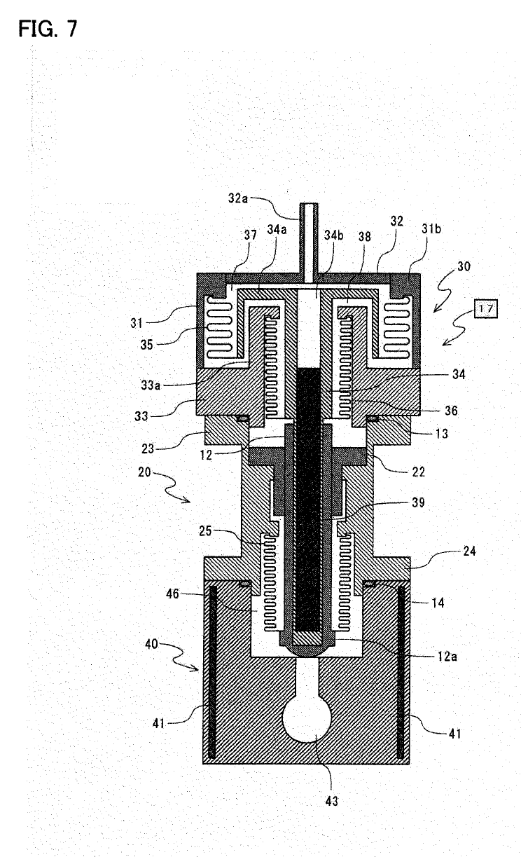

FIGS. 6 and 7 show the fourth example of the embodiment of a highly clean and high temperature valve in accordance with an embodiment of the present invention. FIG. 6 illustrates a vertical cross sectional view of the highly clean and high temperature valve in accordance with an embodiment of the present invention; FIG. 7 illustrates a vertical cross sectional view from other direction of the highly clean and high temperature valve in accordance with an embodiment of the present invention. Only representative symbols are used for the organization that is the same as that mentioned in Embodiment 1, and detailed explanation for them are omitted in FIGS. 6 and 7.

A highly clean and high temperature valve 17 of Embodiment 4 has the connection portion between the valve stem 12 and valve stem 34, which is illustrated in Embodiment 1, and which is extended along the stem direction to the tip of the valve stem 12, and a heater insertion hole 34b is formed in the stem portion 34, and a heating body 39 is placed in the heater insertion hole 34b.

This arrangement enables the valve casing 40 to maintain uniform internal temperature distribution, increase heating efficiency, and decrease a variation in heating efficiency by means of preparing both heating body 39 in the valve stem 34 and the heating body 41 in the valve casing 40.

### Embodiment 5

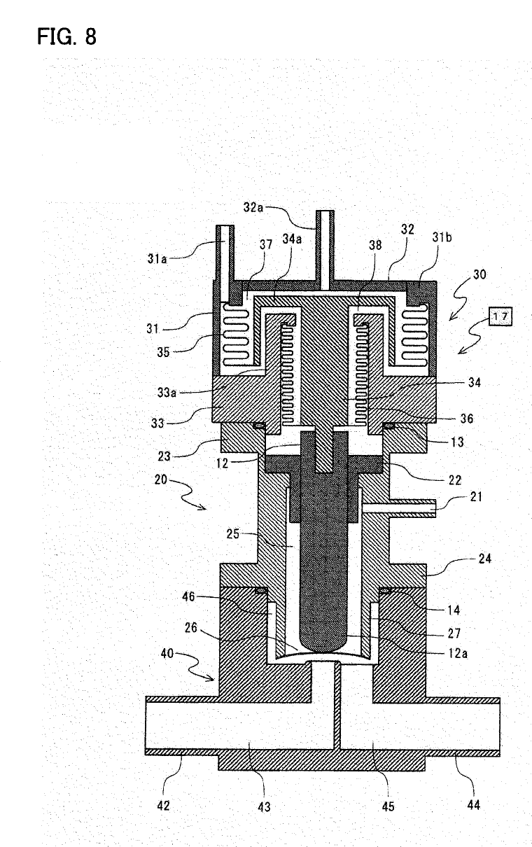

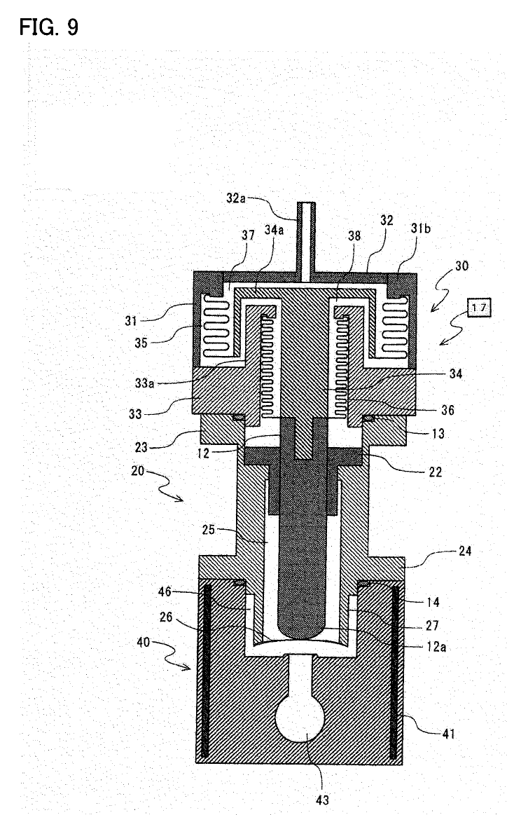

FIGS. 8 and 9 show the fifth example of the embodiment of a highly clean and high temperature valve in accordance with an embodiment of the present invention. FIG. 8 illustrates a vertical cross sectional view of the highly clean and high temperature valve for Embodiment 5 in accordance with an embodiment of the present invention; FIG. 9 illustrates a vertical cross sectional view from other direction of the highly clean and high temperature valve for Embodiment 5 in accordance with an embodiment of the present invention. Only representative symbols are used for the organization that is the same as that mentioned in Embodiment 1, and detailed explanation for them are omitted in FIGS. 8 and 9.

A highly clean and high temperature valve 18 in Embodiment 5 has a similar organization of Embodiment 1 with the third bellows 25 replaced with a diaphragm 26.

The diaphragm 26 is positioned so that the opening of the outlet at the side of a control room 64 of an air intake channel 43 is opened or closed by the movement of the valve stem 12. The diaphragm 26 is fixed in a manner that the opening of the end of a cylindrical portion 27 formed at the bonnet 20 is sealed so that the valve body 12a is surrounded. The diaphragm 26 is made of metal and hermetically fixed by welding so that the cylindrical portion 27 is separated from the control room 46.

This arrangement enables the highly clean and high temperature valve 18 to be used as a highly clean and high temperature valve and enhances the general versatility as a highly clean and high temperature valve.

### Embodiment 6

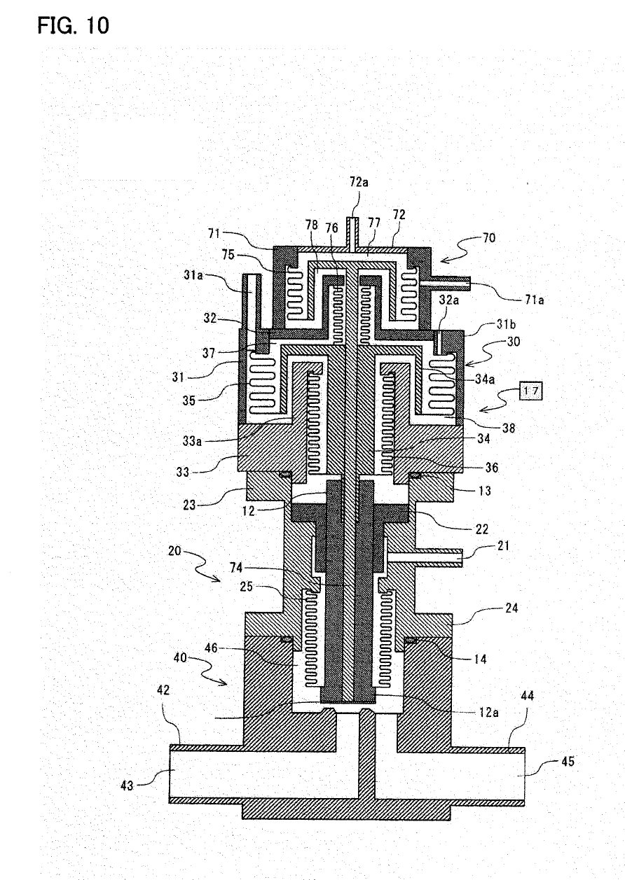

FIG. 10, which shows the sixth example of the embodiment of a highly clean and high temperature valve in accordance with an embodiment of the present invention, is a vertical cross sectional view of the highly clean and high temperature valve of Embodiment 6 in accordance with an embodiment of the present invention. Only representative symbols are used for the organization that is the same as that mentioned in Embodiment 1, and detailed explanation for them are omitted in FIG. 10.

A highly clean and high temperature valve 19 illustrated Embodiment 6 features a multiple-tier structure configured by a driving unit 20 of Embodiment 1 with a second driving unit 70 positioned above.

A second valve driving unit 70 is provided with a second circumferential wall 71, second upper and lower covers 72 and 32 (the second lower cover is also used as the upper cover 32) that closes both ends of the circumferential wall 71, a second stem portion 74 whose one end is positioned in the circumferential wall 71 and that coaxially passes through the lower cover 32 and the stem portion 34 as well as a valve stem 12, a second first bellows 75 connected with one end of the second stem portion 74 so that the inside of the circumferential wall 71 is isolated by the side of the second upper cover 72 and by the upper cover 32, a second second bellows 76 positioned between the upper cover and the stem portion 34, a second first pipe 72a that communicates with a second first space 77 formed between the second upper cover 72 isolated by a second first bellows 75 and one end of a second valve stem 74, and a second second pipe 71a that communicates with a second second space 78 formed between the upper cover 32 isolated by the second first bellow 75 and also isolated from the external space by the second second bellows 76, and one end of a second stem portion 74, thereby to drive the stem portion 74 by increasing or decreasing the fluid volume in the first and second spaces 77 and 78 relative to each other via the first and second pipes 72a and 71a.

This configuration enables the valve to maintain external airtightness to be higher, and thus increase the reliability.

A first pipe 32a of the upper cover 32 as the second lower cover is positioned at the circumferential wall 31, as illustrated in FIG. 10, because multiple-tier valve driving units 30 and 70 are prepared in this embodiment.

In addition, the second stem portion 74 is provided with a diaphragm 79 made of a metal film that opens or closes a flow channel 43 formed in a valve casing 40 by means of drives of the second stem portion 74.

In this case, Rma×0.1 micrometers or less of a surface roughness of the diaphragm 79 can maintain tightness for the flow channel 43.

Meanwhile, the highly clean and high temperature valves 11, 15, 16, 17, 18, and 19 of the present invention can be used for all industrial machines including manufacturing machines that require a maximum reduction of leakage to the outside in a valve and an ultra clean valve eliminating resin at a portion of contact with gas (or liquid), and are not limited to semiconductor manufacturing machines of semiconductor memory devices or various manufacturing machines including FPD manufacturing machines for light-emitting diodes (LEDs), electroluminescence (EL) devices, vacuum fluorescent displays (VFDs), plasma display panel (PDPs), or other devices as previously mentioned.

Moreover, the highly clean and high temperature valve of the present invention can be used as a highly clean and high temperature valve for flow volume control (including closing) for film forming machines of film forming material such as, for example, High-K film (high dielectric constant gate isolation film) using rare metal of rare earth element (light rare earth element) such as lanthanum (La) or praseodymium (Pr), or ferroelectric film using lead (Pb), all of which feature that reactivity and deposition temperature is high, and temperature control is difficult.

Moreover, the highly clean and high temperature valve in this present invention is designed to be used under a high-temperature environment with a temperature of 300 degrees centigrade or higher under a vacuum environment, and therefore, can also be used for various highly clean and high temperature valve used under special environment other than the environments above.

### INDUSTRIAL APPLICABILITY

As explained, the present invention provides with a highly clean and high temperature valve apparatus that enhances the general versatility as a valve apparatus for usage environment.

1-13. (canceled)

14. A highly clean and high temperature valve comprises a valve stem, a bonnet supporting the valve stem slidably, a valve driving unit that drives the valve stem linked to the bonnet to support one end of the valve stem, and a valve casing that is linked to the bonnet so that the valve casing is positioned at the other end of the valve stem, wherein the valve driving unit includes a circumferential wall, an upper cover and a lower cover that close two ends of the circumferential wall, a stem portion whose one end is positioned at the inside of the circumferential wall and that supports the one end of the valve stem with its other end extending through the lower cover, a first bellows linked to the one end of the stem portion so that the inside of the circumferential wall is isolated by the upper cover side and lower cover side, a second bellows that is positioned between the lower cover and the other end of the axial portion and that closes the axial through hole of the lower cover, a first pipe that is made to communicate with a first space formed between the upper cover isolated by the first bellows and the one end of the stem portion, and a second pipe that is made to communicate with a second space formed between the lower cover isolated by the first bellows and isolated from the external space by the second bellows and the one end of the stem portion, wherein the fluid quantities in the first and second spaces are increased or decreased relative to each other, thereby to drive the stem portion with the first and second pipes.

15. The highly clean and high temperature valve according to claim 14, wherein the stem portion is supported in a floating state by the first and second bellows inside the circumferential wall, wherein the stem portion is inserted into the axial through hole in a non-contact state.

16. The highly clean and high temperature valve according to claim 14, wherein the bonnet supports the valve stem slidably and is provided with a bearing member whose material differs in the mechanical property from that of the external circumferential sliding face of the valve stem at the internal circumferential sliding face is welded.

17. The highly clean and high temperature valve according to claim 16, wherein a metal material whose hardness differs from that of the external circumferential sliding face of the valve stem is used for a bearing material.

18. The highly clean and high temperature valve according to claim 14, wherein the bonnet and the valve driving unit are tightly connected and the bonnet is provided with a purge port that control purges in a tightly closed space between the bonnet and the valve driving unit.

19. The highly clean and high temperature valve according to claim 14, wherein a metal gasket is placed at the contact area between the bonnet and the valve driving unit, and at the contact area between the bonnet and the valve casing.

20. The highly clean and high temperature valve according to claim 14, wherein a heating object is incorporated inside the valve casing.

21. The highly clean and high temperature valve according to claim 14, wherein a heating object is incorporated inside the valve stem.

22. A highly clean and high temperature valve, wherein a second valve driving unit is positioned at the upper stage of the valve driving unit, wherein the second valve driving unit includes a second circumferential wall, a second upper cover and a second lower cover that close the both ends of the circumferential wall, a second stem portion having one end positioned in the circumferential wall and extending through the lower cover and the stem portion coaxially as well as the valve stem, a second first bellows linked to the one end of the second stem portion so that the inside of a second circumferential wall is isolated by the second upper cover side and the second lower cover side, a second second bellows that is positioned between a second lower cover and the stem portion, a second first pipe that is made to communicate with a second first space formed between the second upper cover isolated by the second first bellows and one end of the second stem portion, a second second pipe that is made to communicate with a second second space formed between the second lower cover isolated by the second first bellows and isolated by the second second bellows from external environment and one end of the second stem portion.

23. The highly clean and high temperature valve according to claim 22, wherein the one upper cover utilized for both the second lower cover and the upper cover.

24. The highly clean and high temperature valve according to claim 14, wherein a diaphragm is placed that is made of a metal film that opens or closes the flow channel formed in the valve casing by a drive of the valve stem for the valve casing.

25. The highly clean and high temperature valve according to claim 22, wherein a diaphragm is placed that is made of a metal film that opens or closes the flow channel formed in the valve casing by a drive of the valve stem.

26. The highly clean and high temperature valve according to claim 24, wherein a surface roughness of the diaphragm is Rma×0.1 micrometers or less.

27. The highly clean and high temperature valve according to claim 15, wherein the bonnet supports the valve stem slidably and is provided with a bearing member whose material differs in the mechanical property from that of the external circumferential sliding face of the valve stem at the internal circumferential sliding face is welded.

28. The highly clean and high temperature valve according to claim 15, wherein the bonnet and the valve driving unit are tightly connected and the bonnet is provided with a purge port that control purges in a tightly closed space between the bonnet and the valve driving unit.

29. The highly clean and high temperature valve according to claim 16, wherein the bonnet and the valve driving unit are tightly connected and the bonnet is provided with a purge port that control purges in a tightly closed space between the bonnet and the valve driving unit.

30. The highly clean and high temperature valve according to claim 17, wherein the bonnet and the valve driving unit are tightly connected and the bonnet is provided with a purge port that control purges in a tightly closed space between the bonnet and the valve driving unit.

31. The highly clean and high temperature valve according to claim 15, wherein a metal gasket is placed at the contact area between the bonnet and the valve driving unit, and at the contact area between the bonnet and the valve casing.

32. The highly clean and high temperature valve according to claim 16, wherein a metal gasket is placed at the contact area between the bonnet and the valve driving unit, and at the contact area between the bonnet and the valve casing.

33. The highly clean and high temperature valve according to claim 17, wherein a metal gasket is placed at the contact area between the bonnet and the valve driving unit, and at the contact area between the bonnet and the valve casing.
